(19) United States
(12) Patent Application Publication
(10) Pub. No.: US 2024/0334000 A1
(43) Pub. Date: Oct. 3, 2024

(54) AUTOMATED PICUTRE-IN-PICTURE POSITIONING AND FORMATING

(71) Applicant: Adeia Guides Inc., San Jose, CA (US)

(72) Inventor: Tao Chen, Palo Alto, CA (US)

(21) Appl. No.: 18/129,562

(22) Filed: Mar. 31, 2023

(51) Int. Cl. H04N 21/431; H04N 21/462

(52) U.S. Cl. CPC H04N 21/4316; H04N 21/4622

(57) ABSTRACT

A first window, for example, a picture-in-picture (PiP), is displayed on a user device to avoid obscuring displayed items of a second window, when the displayed items are determined to have priority relative to the first window contents, for example, newly received notifications. A PiP may be positioned at a top or bottom of the display to avoid obscuring the priority displayed item(s), or may be made smaller or made partially translucent to avoid obscuring the priority displayed item(s). Standard position and format PiP may be resumed if the displayed item is deemed to have lost priority.

### BACKGROUND

One or more embodiments of the present disclosure relate to automatically positioning and formatting a window that provides a picture-in-picture (PiP) and, more particularly, to positioning and/or sizing or otherwise formatting the PiP window in a display of a device so as to avoid obstructing or obscuring important aspects of items displayed in another window of the display. Some disclosed embodiments or aspects may relate to other features, functionalities, or fields.

### SUMMARY

Smartphones and other user devices commonly provide picture-in-picture (PiP) modes. In a typical example, activating a PiP mode involves overlaying a second or secondary window (e.g., a window displaying a video) on top of a first or primary window (e.g., a window displaying a search interface, a browser, etc.). A “window” is an area, on screen, for example, where information is displayed. In the context of PiP, the “first window” or “primary window” may take up most or all of the available screen. Some may refer to the first window as an underlying window or display, a “first display,” or a “primary display.” Similarly, some may refer to the second window as a PiP window or display, a floating window or display, a “second display,” a “secondary display,” etc. In some instances, the first and second windows may be thought of as having distinct sources or applications that generate the displays provided within each window. With that said, in some instances, the displays provided via the first and second windows may be provided by the same source, application, set of applications, etc. Each of the first and second windows may include multiple windows in some instances. For example, the first window may include a first window or sub-window for a browser and a second window or sub-window for a video player. In any event, in example operation, a PiP mode may be manually or automatically initiated when a user consuming media content in an initial window of a display of a handheld device receives a text message via a messaging application or wishes to search the web using a browser application of the device. The media content may be a movie being streamed or recorded on the device, a television or other broadcast, a video conference with another user, or the like. The content may continue to be displayed as a PiP window while the user views the text or interacts with the browser application in a first (e.g., primary) window of the device's display.

The PiP mode thus allows the user to multitask, however, the PiP window may become a nuisance. The PiP window is typically displayed in a standard size and is typically displayed at a top or at a bottom of the screen of the device. This may obscure critical portions of the first (e.g., primary) window, for example, new messages received in a messaging application or a virtual keyboard or a navigation bar of the browser application with which the user is interacting. The user may miss messages, or may fail to see them until much later. In some instances, the user may “drag” the PiP window to a less important portion of the display or to hide or minimize it. However, this imposes additional steps on the user and may feel irksome to the user. A novice user may not know how to move the PiP window around the screen, or may not know that the second (e.g., secondary) window can be moved around at all. Also, after the PiP window is dragged, it may remain in place until the user again drags it or removes it. However, in the course of interacting with the application the critical portions of the primary window may change. For example, as the user begins writing a response to the message, the PiP window, as initially re-positioned by the user, may now block a portion of the newly critical portion. Thus, repeated user moving of the PiP window may be necessary just to view a single message and to send a single reply.

According to an aspect of the methods herein described, a second window (e.g., a secondary window) of a PiP window may be modified (e.g., automatically) based on an analysis of content or items displayed via the second window and/or a first window (e.g., a primary window). The modification may include modifying a size, shape, position, orientation, and/or transparency of the second window, depending on the embodiment. The analysis may include an analysis of: (i) content or items provided via the second window; (ii) content or items provided via the first window; (iii) on-screen positions of the content or items provided via the first window; and/or (iv) on-screen positions and/or dimensions of the second window (from which a “blocked” region of the first window is determinable. In an embodiment, a user may be consuming content when interaction with a second application of the device is initiated. For example, initially a user may be consuming video content in full screen mode, or the video content may already be displayed in a PiP window. Then, a text message or other user notification may be received by the device from another user and a messaging application of the device may generate a display in a first (e.g., primary) window of a graphical user interface (GUI) that includes the newly received message together with older messages. The system may display the recently received message (sometimes referred to as the displayed item) and the older messages in the first (e.g. primary) window generated by the messaging application. Or, the user may be consuming the video content and may decide to start using another application of the device, which may trigger the system to display a user interface with the new application in the first window while providing the video content in a PiP window. In one example, a user may navigate to a home screen, resulting in the activation of PiP mode for the video content. In such an example, the device displays the home screen in a first window or display while simultaneously displaying the video content in a second window. The system may determine that the displayed item has priority over the initially consumed video content, for example, based on how recently the displayed item is received relative to when the user last interacted with the content being consumed, how recently the user interacted with the displayed item, or characteristics of the displayed item that the system deems inherently to have priority. For example, texts from other users, calendar reminders, alarms set by the user, some notifications generated by the operating system or by other applications, some applications or some displayed items generated by one or more applications, may be determined to have priority over media content being consumed by the user. The displayed item may be determined to have priority relative to other items or content, such as the items or content displayed in the first window.

Further, a history of user interaction with items similar to the displayed item may be consulted to determine priority. For example, it may be determined whether the user responds to a group of items considered to be “messages” (e.g., text messages, WhatsApp messages, or the like) within a predetermined average time that is less than a threshold time, or responds within a predetermined time that is less than a threshold time, or responds to a first user or first group of users within a predetermined time that is less than a threshold time after such a text or message is first notified to the user by the device. If so, then a text or message received from any other user, or a text or message received from the first user or first group of users, may be deemed to have priority.

If such a priority is determined for the displayed item, then a position or format—e.g., size, transparency—of the second (e.g., secondary) window may be automatically adjusted so that the content of the second window is displayed without obscuring the displayed item deemed to have priority in the first (e.g., primary) window of the display.

Further contemplated is a dynamic, automatically floated PiP window, in which the PiP window moves if it is determined that the displayed item with priority has moved. For example, a messaging application may generate a display of a text exchange. As additional messages are received or typed, messages may become obscured. The PiP window may be re-positioned automatically as the additional messages are received so as to avoid blocking the most recent messages in the chain, or so as to avoid the originally received message and the most recent message, or the like. As more and more items of the first (e.g., primary) window are deemed to have priority, the PiP window may be re-sized smaller. As a further approach, if the PiP window could not be displayed at a reasonable size without obscuring the messages, then the PiP window could be reformatted to transparent mode such that both the PiP window and the messages are visible.

According to an embodiment, when the item loses priority status, the second (e.g., secondary) window may be restored to a previous position and format. The previous position and format may be a standard position and standard format that the operating system of the device predetermines for providing the type of content.

Also, contemplated is an auto hide mode for the PiP window, which may be useful if there are too many priority display items on the display to accommodate also the PiP window. The auto hiding of the PiP window may be ended and the PiP window may be recovered and displayed when one or more priority display items are no longer displayed on the display or when one or more priority display items are determined to have lost their priority status.

A communication control method, system, device, non-transitory computer-readable medium, and means for such a method are described. Such a method may include any one or more of: generating for display content on a display of a user device; generating for display, on the display of the user device, a second window that includes a displayed item; determining that the displayed item has priority relative to the content; and in response to the determining, generating for display the content in a second window on the display simultaneously with the display of the second window, wherein the content is positioned or formatted to avoid obscuring the displayed item.

For example, the second window may be displayed as a picture-in-picture overlaid on the second window in a position to avoid obscuring the displayed item. In an embodiment, the second window is provided in response to the system activating PiP mode, which may happen when the user navigates away from an application or interface providing particular content (e.g., video). In such an example, the system may provide the particular content in the second window. By way of further example, the second window may be displayed as a PiP window overlaid on the first window in a format to avoid obscuring the displayed item. Such a format may be a sufficiently transparent format to allow simultaneous visibility of both the displayed item and the content. The second window may be placed at a different position than a default or predetermined picture-in-picture position to avoid obscuring the priority displayed item or items.

In some instances, the first or second windows may be displayed in a “windowed” mode wherein the two windows are simultaneously displayed on the screen without one being superimposed on the other. In such an example, the first or second windows may be positioned, sized, or modified to avoid obscuring prioritized displays items of the first window. For example, the first window may be sized such that the second window is displayed in a window adjacent to the first window simultaneously with the display of the first window. For example, the first window may be formatted to take up less than the entire display to leave room for the second window side by side with the first window while leaving sufficient space to adequately display the display items in question in the first window.

In any event, the displayed item of the first window may be determined to have priority (e.g., relative to one or more content items displayed in the second window) if it is a user notification generated by a messaging application of the device. For example, the displayed item may be determined to have priority based on a time of receipt of the notification or based on a time of its generation. In addition, the displayed item may be determined to have priority based on a stored pattern of user interactions with the type of item that is the displayed item. For example, if the user of the device usually responds promptly to messages receives from the contact who sent this notification, then the notification may be displayed as a priority display item.

The displayed item of the first window that has priority over the second window content may change over time. By way of illustration, the displayed item may be determined to have lost the priority in response to a scrolling user input, a cursor user input, a return to the home screen, or an expiration of a priority time interval.

The first window may be generated by a first application and the second window may be generated by a second application different from the first application. For example, one or both applications may be running on the user device.

Also, contemplated is a continuous process of determining a location on the display of one or more priority items and avoiding obscuring them by the second window. Thus, it may be determined that the displayed item is positioned at a second location of the display different from the first location at which it was previously displayed, and in response the second window may be re-positioned to avoid obscuring the displayed item. Also, it may be determined that the displayed item has lost the priority and, accordingly, the second window may then be positioned and formatted in the default or predetermined or standard PiP window manner.

In an embodiment, if a change to the first window is determined, for example, if a new first window content is provided in the first window, or if a different application provides the content for the first window, then a second displayed item of the first window may be determined to have priority relative to the content of the second window, and in response the content in the second window may be simultaneously displayed with the display of the first window such that the second window is positioned or formatted to avoid obscuring the second displayed item of the first window. For example, if the user navigates to the home screen, or to a different application, the first window will be changed, and accordingly, newly displayed items may be deemed to have priority over the second window. Thus, the first window may be generated by a first application and the second window may generated by a second application different from the first application. For example, the system may receive user input that initiates launching the first window on the display and, in response, the picture-in-picture mode may be launched with the PiP window overlaid on the first window.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following FIGs. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIGS. 1A-B illustrate examples of a second window formatted and positioned, respectively, on a display to avoid obscuring messages with priority, according to an aspect of an embodiment;

FIGS. 2A-C illustrate examples of a PiP window that obscures various displayed items of a window containing a home screen of a smartphone, as known from related art;

FIGS. 3A-C illustrate examples of PiP window shown in standard sizes and standard positions obstructing another window of a device, as known from related art;

FIG. 4A illustrates an example of a window showing interaction with a bot application and without a second window on a display of a device, as known from related art;

FIGS. 4B-C illustrate the example of the window shown in FIG. 4A but with a second window that has been manually dragged by a user to reveal portions of the window showing interaction with the bot application, as known from related art;

FIGS. 5A-B illustrate an example of a second window being interacted with to hide and to reveal the second window overlaid over a home screen of a user device, as known from related art;

FIGS. 6A-B illustrate an example of second window being re-formatted to become sufficiently transparent to render both the second window and displayed items over which the second window is overlaid to be visible, according to an aspect of an embodiment;

FIG. 7A illustrates an example of a window generated by a social network application sized and positioned adjacent a second window to avoid overlapping with displayed item that has priority, according to an aspect of an embodiment;

FIG. 7B illustrates the example of FIG. 7A with a new displayed item with priority and the second window positioned to avoid it, according to an aspect of an embodiment;

FIG. 8 illustrates an example of a computer device and accessories/components thereof, as known from related art;

FIG. 9 is a flowchart illustrating an example of a process for automated second window control, according to an embodiment;

FIG. 10 is a flowchart that illustrates an example of a process for avoiding display of the second window that would obscure priority display items of a first window, according to an aspect of an embodiment;

FIG. 11 is a flowchart that illustrates an example of a process for positioning the second window, according to an aspect of an embodiment;

FIG. 12 is a flowchart that illustrates an example of a process for an auto hide and recovery of a second window, according to an aspect of an embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood that the embodiments and examples described herein may be practiced without these specific details. In other instances, well-known methods, procedures and components, including software, firmware and hardware components, have not been described in detail so as not to obscure the embodiments described herein. Also, the description is not to be considered as limiting the scope of the embodiments described herein.

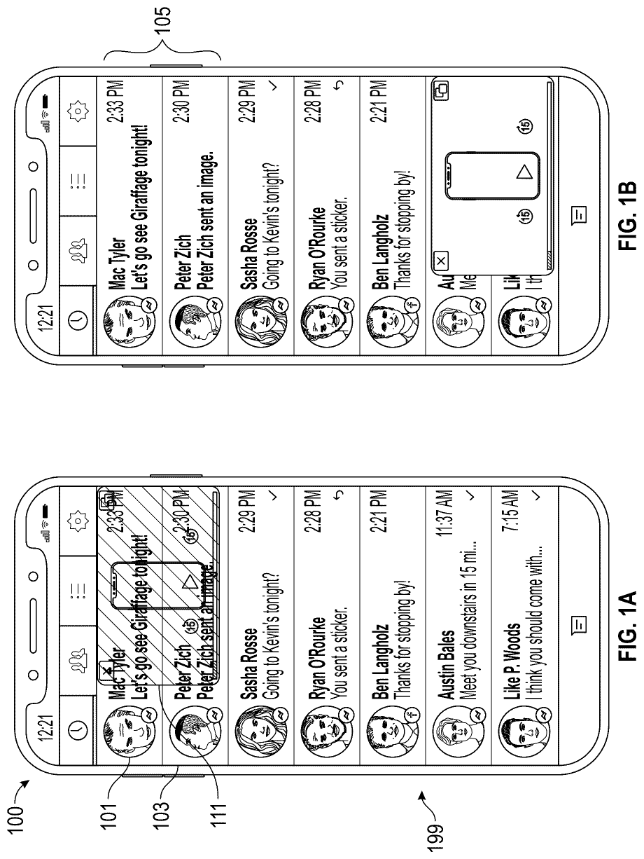

FIGS. 1A-B illustrate embodiments in which a second window 111 is positioned overlaid on a first window 103 generated by a messaging application of a user device 100 on the screen 101 of the device 100. The second window 111 may be a video that was being consumed by a user of the device 100 before a message was received and the user may wish to continue to consume contemporaneously with the user's interaction with the messaging application on the device 100. FIG. 1A illustrates an embodiment in which the second window 111 is a PiP window 111 that is partially transparent to allow the user to view both the content of the second window 111 and the unread messages shown at the top of the first window 103 generated by the messaging application. The top messages are shown in bold by the messaging application to indicate that they have not been read. These messages may be the display items 105 that the system 199 determines to have priority-more important or critical information of the first window 103 that should not be obscured or obstructed by the second window 111. The system 119 may include hardware and software components that provide the described functionality. In some embodiments, the system 199 is, or includes, the device 100. In some embodiments, references to the “system 199” refers to the device 100 and any servers or devices (not shown) that the device 100 is communicatively coupled with, or somehow interacts with, to provide the described functionality. For example, the system 199 may provide video at the device 100 by way of the device 100 receiving a video stream from a server and by displaying the video stream.

The second window 111 may be provided as a picture in picture (PiP) display that may play or provide various types of media content, including broadcast content, such as television or cable television broadcast or streaming content, including pay-per-view content, media content previously downloaded or recorded onto the user device, including commercially produced content, home videos, photographs, music or other media, video feed or other media provided by a social media network or a messaging or communications application, such as WhatsApp, Zoom, Skye or the like, other online media provided by a browser or other applications that include media files, applets, and the like.

While sometimes referred to as a second window 111, it will be understood that other types of graphical control elements of a user interface are also contemplated. For example, a graphical control element may be one or more graphical widget(s) or panel(s) that provide(s) content to the user. The content may be provided by an application or applet hosted by the device, an operating system of the device, or may be otherwise streamed from the cloud or a local network. Similarly, the first window 103 that includes the priority display items 105 is sometimes referred as being provided in a window, however, it will be understood that other types of graphical control elements of a user interface are also contemplated for providing the output of the application. This graphical control element may be one or more graphical widget(s) or panel(s) that provide(s) content to the user. The first window 103 may be provided by an application or applet hosted by the device, an operating system of the device, or may be otherwise streamed from the cloud or a local network. The application providing first window 103 may be hosted locally or elsewhere. The first window 103 is illustrated as being in the portrait mode, with the device 100 oriented “vertically,” the first window 103 may also be provided in a landscape mode. In either mode of the first window 103, second window 111 may be provided in a landscape mode, as illustrated, or in a portrait mode.

Some of the figures illustrate examples of smartphones as the device 100. Other types of data processor-based devices, including desktops, laptops and other portable computers, including handheld devices, such as tablets, are also contemplated.

FIG. 1B illustrates that the second window 111 is positioned so as to avoid obscuring the unread messages—the priority displayed items 105. The system may determine that unread messages have priority and so position and/or format the second window 111 so it does not obscure the displayed items 105 with priority. In this case, since the displayed items 105 with priority are provided near the top of the screen, the second window 111 is positioned near the bottom of the screen 101. The second window 111 shown in FIG. 1A formatted as partially transparent may also be positioned at or near the bottom of the display 101 to avoid overlaying the displayed items 105 deemed to have priority, for example, so that it interferes even less with the displayed items 105 with priority.

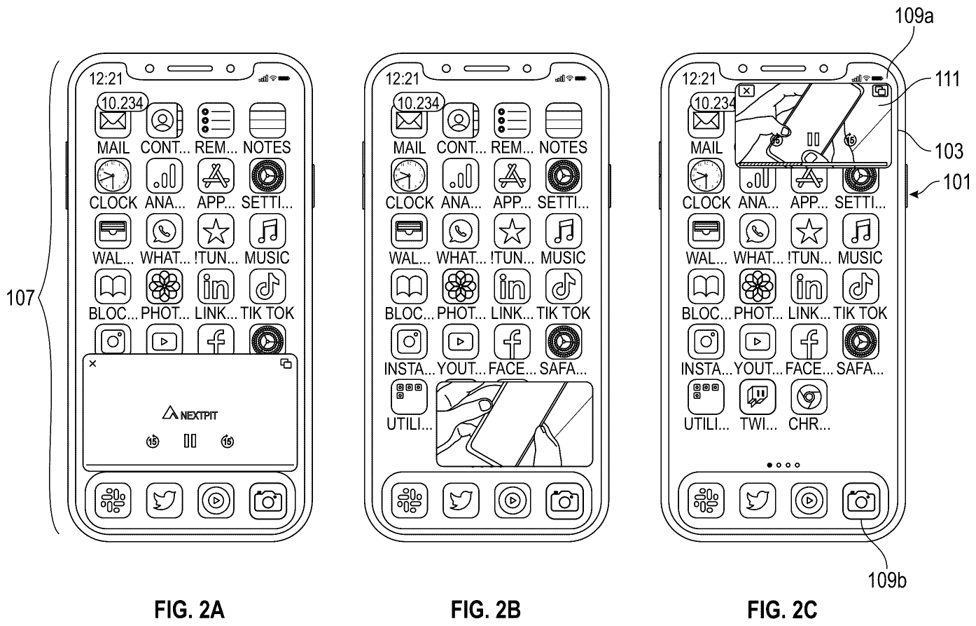

FIGS. 2A-C illustrate second windows 111 provided as PiP windows in sizes and positions that are default or standard for some operating systems of mobile devices. FIG. 2A shows a PiP window positioned in a standard size over substantially an entire bottom portion of a “payload” portion 107 of a display 101 of the smartphone. The payload portion of the display may be thought of as the main portion of the display area above the dock 109b, which may be almost always present on the home screen in standard mode, and which shows frequently used applications that may be “fixed” on the home screen, and below a top portion 109a that is often present and shows system status icons, such as battery and WiFi status, cellular service status, time/date, and other such information.

FIG. 2B illustrates the PiP window 111 at the bottom of the display above the dock in a size that is the smallest standard size, typically half or just over half display length, in the landscape mode of the PiP window 111. FIG. 2C shows the PiP window 111 size near the top of the display below system icons.

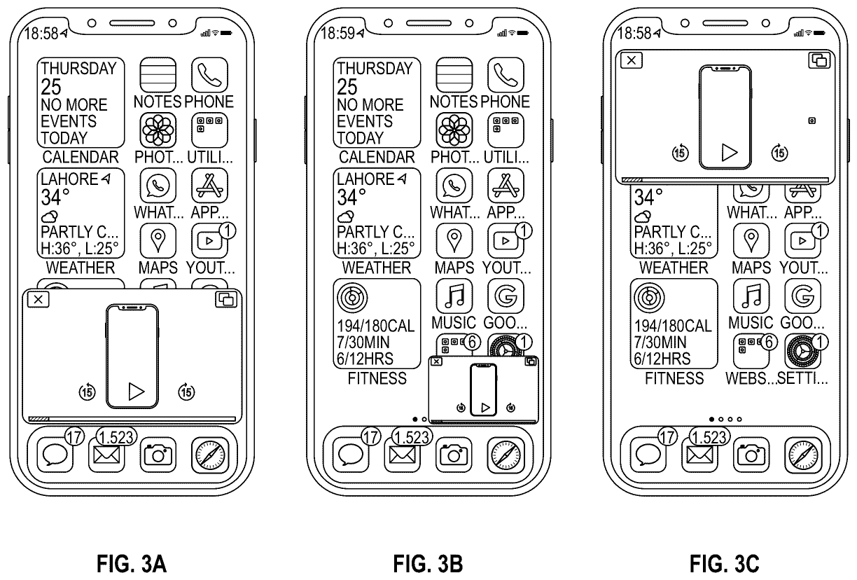

FIGS. 3A-C show the PiP window 111 at positions and in sizes standard as determined by the Operating System of the device 100. FIGS. 3A-C show the PiP window 111 near the bottom of display above the dock in a first standard size, FIG. 3B shows the PiP window 111 in a second standard size that is the smallest standard size of the device, and FIG. 3C shows the PiP window 111 at the top position near the top of the display below system icons in the first standard size.

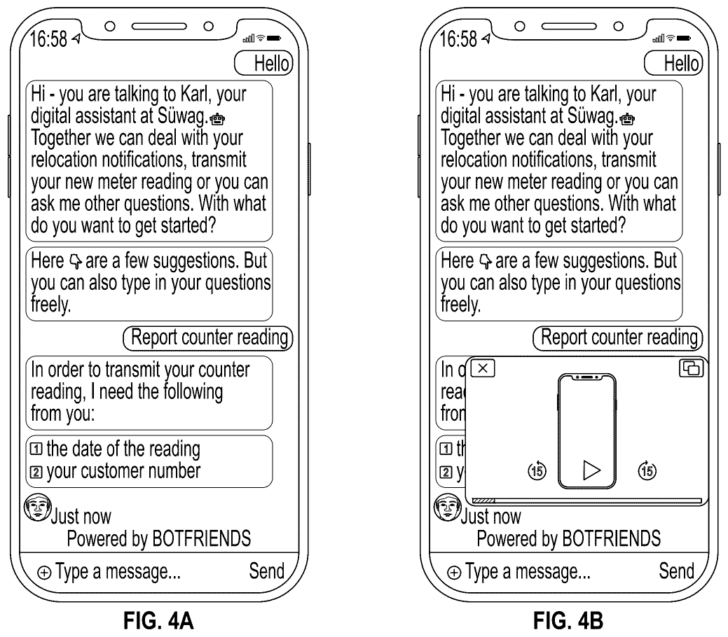

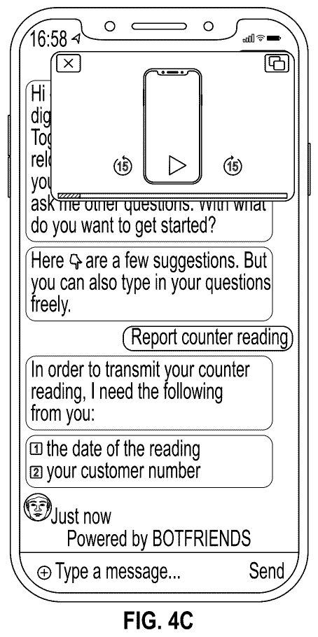

FIG. 4A illustrates a first window 103 generated by an application providing user interaction with someone or with a bot. FIG. 4B illustrates the same window 103 when the system generates a second window 111 that shows a video as a PiP window 111. According to the related art, the user manually has dragged down the PiP window 111 to a lower portion of the screen 101 so the user can read the top portion of the screen 101. Then, as illustrated in FIG. 4C, when the user needs to interact with the bottom of the screen provided by the application, the user has dragged up the PiP window 111 to near top of the screen.

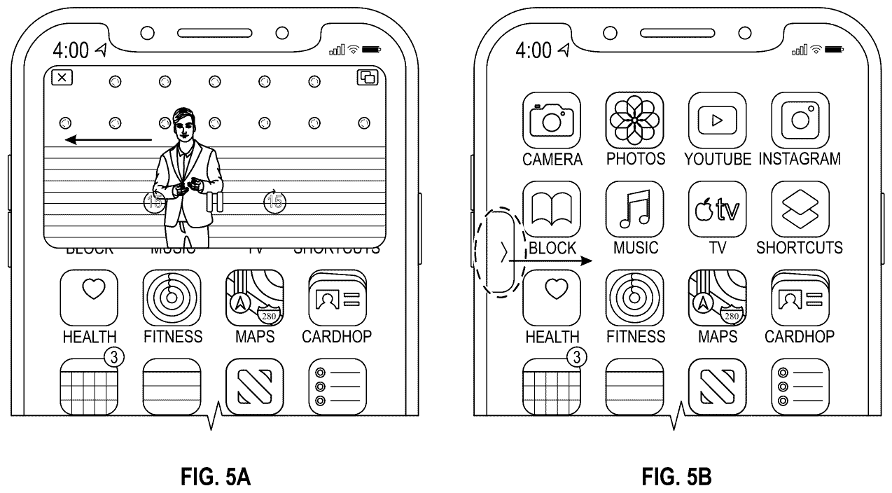

FIGS. 5A-B illustrate another way that users have dealt with a picture-in-picture that blocks important portions of the window 103 generated by an application with which they are interacting. FIG. 5A illustrates that the picture-in-picture blocks icons representing applications on a home screen of the device. The red arrow shows that the user first swipes the picture-in-picture to the left to hide the picture-in-picture. Then, as shown in FIG. 5B, the user may swipe right on the PiP window 111 stub that remains on the screen in order to watch the picture-in-picture.

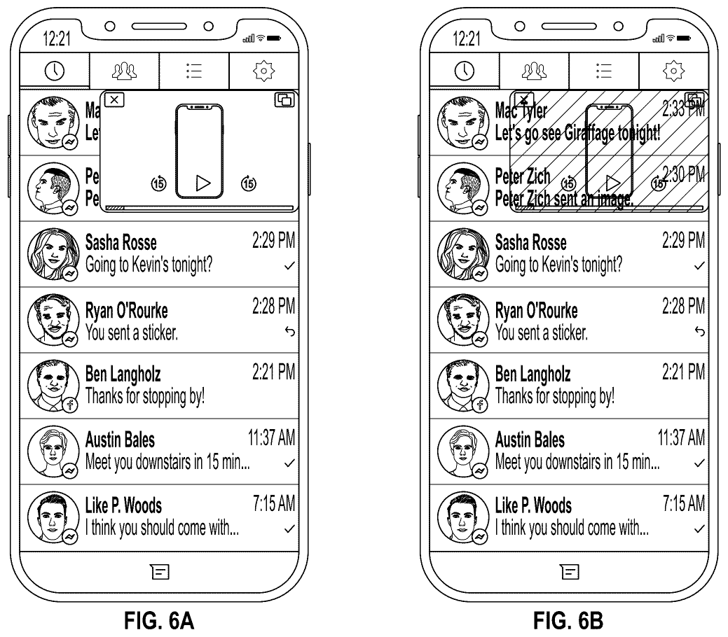

FIGS. 6A-B illustrate, respectively, the standard and partially transparent mode for second window 111. In FIG. 6A, second window 111 obscures most of the priority display items—the unread new messages of the first window 103. As illustrated in FIG. 6B the second window 111 at 35% transparency allows the user to both experience the content shown by the second window 111 and to see the displayed items 105 with priority of the other window. This 35% transparency may be sufficient for the user to see whether the user is interested in reading the messages provided in the example or may be sufficient actually to read the messages.

While shown at 35% transparency, second window 111 may be set at other transparencies more or less than 35%, for example, as high as 85% or as low as 15%. According to an embodiment, the degree of transparency may be set according to the type of content. The content provided by the second window 111 may be audio centric, such as a musical piece with album cover, cover art, or an image of the performer or composer continuously displayed in the window. If the first content is audio-centric, then the second window 111 may be made highly transparent so as to keep the user aware of the content and “where” it is being played on the device but to facilitate user interaction with the first window 103.

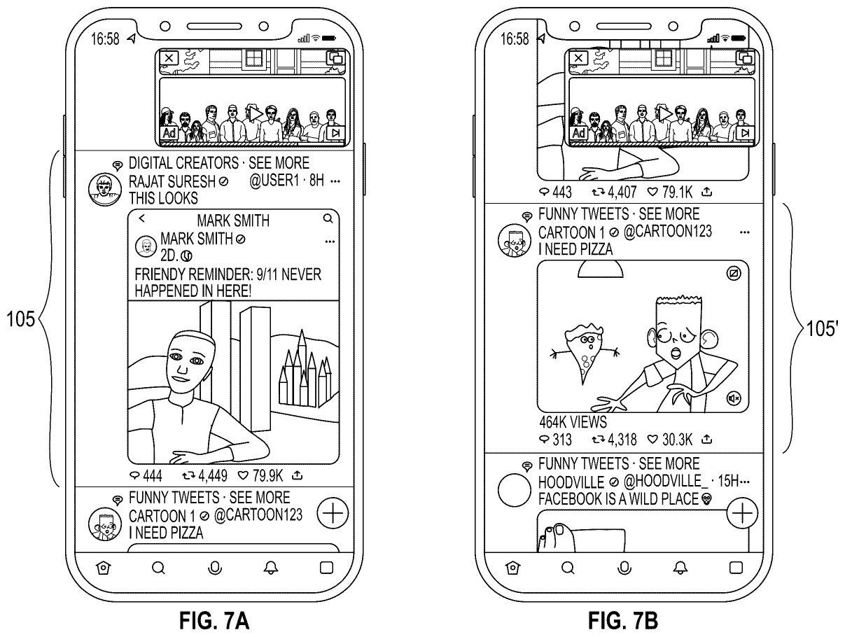

FIG. 7A illustrates another embodiment in which the second window 111 is positioned adjacent to the first (e.g., primary) window 103 when it includes a displayed item with priority 105. As illustrated in FIG. 7A, the first (e.g., primary) window 103 may be scaled or adjusted in size to make room on the display 101 for the second window 111. The first (e.g., primary) window 103 may be adjusted to a smaller size, for example, because the social media feed that it contains is being displayed from the beginning portion. Thus in the example shown in FIG. 7A, the system may determine that the priority display items 105 of the first window 103 can be entirely displayed at a readable size with sufficient room left on the display 101 for the first window 103 adjacent the first window 103.

As shown in FIG. 7B, as the user scrolls down to reveal a lower portion of the social media network feed, it is determined that the user has scrolled past the priority displayed items 105 of FIG. 7A, which have now lost priority, and a new priority displayed item 105′ is shown in the first window 103. In the example, the primary or first window 103 is adjusted to standard size to give the user an indication of the continuity of the new priority displayed item 105′ with the previous displayed items, and the second window 111 may be positioned as PiP window on top of the first window 103.

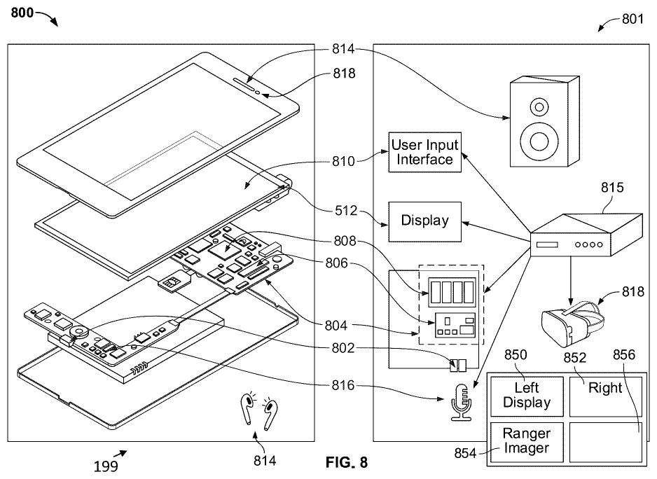

FIG. 8 illustrates components and related hardware for applications of the device 100, that implements providing two windows simultaneously as described herein. A circuit board may include control circuitry, processing circuitry, and storage (e.g., RAM, ROM, hard disk, removable disk, etc.). In some embodiments, the circuit board may include an input/output path. Each device 800/801 may be thought of or comprise a system 199 that may receive content and data via input/output (I/O) path 802 that may comprise I/O circuitry (e.g., network card, or wireless transceiver). I/O path 802 may communicate over a local area network (LAN) or wide area network (WAN).

Control circuitry 804 may comprise processing circuitry 806 and storage 808, and may comprise I/O circuitry. Control circuitry 804 may be used to send and receive commands, requests, and other suitable data using I/O path 802, which may comprise I/O circuitry. I/O path 802 may connect control circuitry 804 (and specifically processing circuitry 806) to one or more communications paths (described below), and may receive notifications and transmit them, for example, via an operating system of the device and/or via additional applications, to a user communications application as well as to the application that control the primary and secondary windows displays, including the PiP window. I/O functions may be provided by one or more of these communications paths, but are shown as a single path in FIG. 8 to avoid overcomplicating the drawing.

Control circuitry 804 may be based on any suitable control circuitry such as processing circuitry 806. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i7 processor). In some embodiments, control circuitry 804 executes instructions for the application stored in memory (e.g., storage 808). Specifically, control circuitry 804 may be instructed by the application to perform the functions discussed above and below. In some implementations, processing or actions performed by control circuitry 804 may be based on instructions received from the AR application.

In client/server-based embodiments, control circuitry 804 may include communications circuitry suitable for communicating with other networks. The application may be implemented as software or a set of executable instructions. The instructions for performing any of the embodiments discussed herein of the application that controls the positioning, size, transparency, auto-hiding and revealing, and/or other formatting of the PiP window 111 and/or of the first window 103 may be encoded on non-transitory computer-readable media (e.g., a hard drive, random-access memory on a DRAM integrated circuit, read-only memory etc.). For example, in FIG. 8, the instructions may be stored in storage 808, and executed by control circuitry 804 of a device 800.

In some embodiments, the application may be a client/server application where only the client application resides on device 800 (e.g., device 104), and a server application resides on an external device or edge network. Control circuitry 804 may include communications circuitry suitable for communicating with a server, edge computing systems and devices, a table or database server, or other networks or servers Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video recorders, solid state devices, quantum storage devices, gaming consoles, or any other suitable fixed or removable storage devices, and/or any combination of the same. Storage 808 may be used to store various types of content described herein as well as AR application data described above (e.g., database 420). Nonvolatile memory may also be used (e.g., to launch a boot-up routine and other instructions). Cloud-based storage, described in relation to FIG. 8, may be used to supplement storage 808 or instead of storage 808.

Control circuitry 804 may include video generating circuitry and tuning circuitry. Control circuitry 804 may also include scaler circuitry for upconverting and down converting content into the preferred output format of equipment 800. Control circuitry 804 may also include digital-to-analog converter circuitry and analog-to-digital converter circuitry for converting between digital and analog signals. In some embodiments all elements of system 800 may be inside housing of the display device 818. In some embodiments, display device 818 comprises a camera (or a camera array) 856. Video cameras 856 may be integrated with the equipment or externally connected. One or more of cameras 856 may be a digital camera comprising a charge-coupled device (CCD) and/or a complementary metal-oxide semiconductor (CMOS) image sensor. In some embodiments, one or more of cameras 856 may be dirtied at outside physical environment (e.g., two cameras may be pointed out to capture to parallax views of the physical environment). In some embodiments, display device 818 may comprise other biometric sensor or sensors to measure eye rotation (e.g., electrodes to measure eye muscle contractions). display device 818 may also comprise range image 854 (e.g., LASER or LIDAR) for computing distance of devices by bouncing the light of the objects and measuring delay in return (e.g., using cameras 856). In some embodiments, display device 818 comprises left display 850, right display 850 (or both) for generating VST images, or see-through images in accordance with embodiments in FIGS. 1-6.

The application that controls first and second window placement and formatting may be implemented using any suitable architecture. For example, it may be a stand-alone application wholly implemented on each one of user equipment device 800 and user equipment device 801. In such an approach, instructions of the application may be stored locally (e.g., in storage 808), and data for use by the application is downloaded on a periodic basis (e.g., from the edge network, from an out-of-band feed, from an Internet resource, or using another suitable approach). Control circuitry 804 may retrieve instructions of the application from storage 808 and process the instructions to provide generation functionality and preform any of the actions discussed herein. Based on the processed instructions, control circuitry 804 may determine what action to perform when input is received from user input interface 810. For example, head movement or movement of a cursor on a display up/down may on user input interface 810. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the application may be downloaded and interpreted or otherwise run by an interpreter or virtual machine (run by control circuitry 804). In some embodiments, the application may be encoded in the ETV Binary Interchange Format (EBIF), received by control circuitry 804 as part of a suitable feed, and interpreted by a user agent running on control circuitry 804. For example, the application may be an EBIF application. In some embodiments, the application may be defined by a series of JAVA-based files that are received and run by a local virtual machine or other suitable middleware executed by control circuitry 804. Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network. While sometimes described as an application by way of example, it will be understood that operating systems and other system modules and notifications and outputs are also contemplated.

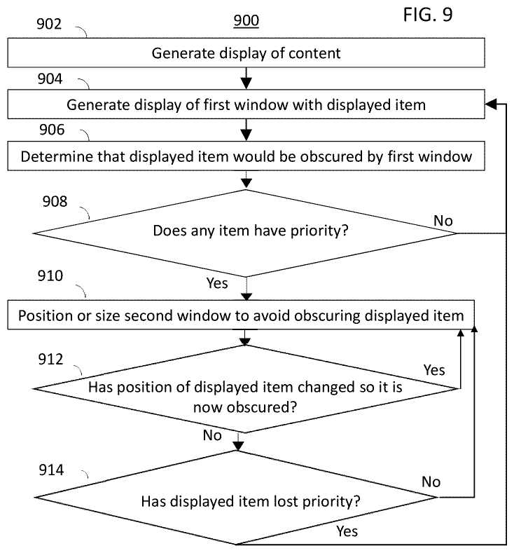

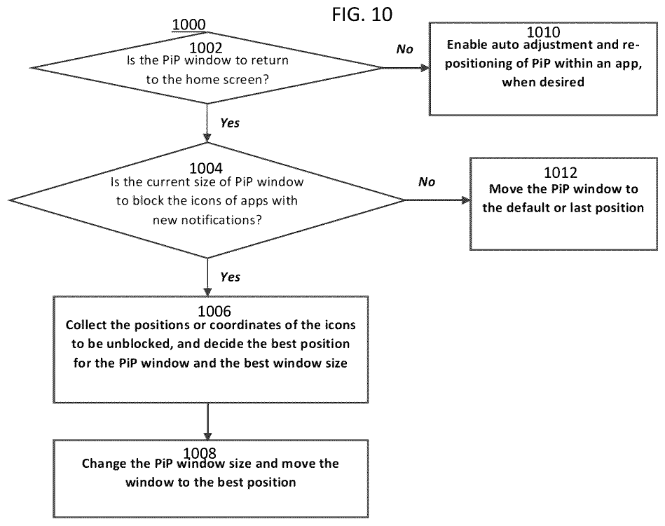

FIG. 9 shows a flowchart for a method 900 according to an aspect of the disclosure. The method 900 may be implemented, in whole or in part, by the system 199 shown in FIG. 1 or the system 199 shown in FIG. 8. One or more actions of the method 900 may be incorporated into or combined with one or more actions of any other process or embodiments described herein. The method 900 may be saved to a memory or storage (e.g., the storage 808 of the system 199 shown in FIG. 8) as one or more instructions or routines, which may be executed by any suitable device or system having access to the memory or storage to implement the method 900.

At 902, a first window with content is generated. For example, the user may be watching a movie broadcast or otherwise streamed or downloaded to the device, or the user may be interacting with one or more other users in a Zoom video meeting or a video chat provided by another communication application.

At 904 of FIG. 9, the system may generate a first window 103 with one or more displayed items. For example, the device may receive a text or other message, or the user may press the home button to access the home screen, or the user may start interacting with the browser application or another application of the device. The first window 103 may be thought of as a first (e.g., primary) window if the user has navigated to it more recently than when the user started playing the content or if the system determines based on other factors that the user may wish to view contents of the first window 103 immediately.

At 906 the system determines that one or more displayed items of the first window 103 would be obscured by display of the second window 111. This may be the case when the first window 103 is a first (e.g., primary) window that takes up all or most of the payload space of the screen and the second window 111 were to be provided as a PiP window overlaid on the first window 103.

It may then be automatically determined, at 908, whether a displayed item of the first window 103 that would be obstructed by second window 111 has priority. For example, an unread text or message, an unheard recording sent by another user may be deemed to be a displayed item 105 with priority. Similarly, portions of a social media network feed or a news feed that has not been displayed to the user may be deemed to have priority. A virtual/soft keyboard and text entry bar generated on the screen 101 of the device to facilitate a user response to the text or message, or to the social media feed, may also be deemed to have priority. Similarly, the virtual/soft keyboard and navigation bar generated on the screen 101 of the device by the browser to facilitate user access to the internet may be deemed to have priority. System searching bars and user access widgets may also be deemed to have priority. A dial pad for telephone dialing may also be deemed to have priority. In addition, system notifications, such as low battery indicators, or other urgent system updates, and the like may be determined to have priority.

Another way of determining a priority displayed item 105 may be by predicting where a user's attention is likely to be on the screen. If a user interacts with the virtual keyboard, scroll bars, highlighting tools, soft buttons for replying or sending texts or messages, or other user navigation tools or widgets, then such items may be determined to be priority display items 105. If the user is otherwise providing input, such as via a dictation to a virtual assistant or to a dictation software, then display items associated with such user input or interaction may be deemed to be priority displayed items 105.

A user's interactions with the user interface for various applications may be tracked to determine usual or typical user patterns, and such patterns of user interactions may be used to predict user interactions for an application that the user is now using. The predicted user interaction may then be used to determine the priority displayed item 105. For example, it may be determined that when reading a newly received text message, user often scrolls up to check the time at which the text message was received. If such a pattern is determined for the user, then the time of receipt would be determined to be a priority displayed item 105.

Past user interactions with specific other users may also be consulted to determine whether a received text or other type of message has priority. For example, a whitelist may be maintained: texts or other messages received from contacts on the whitelist may be deemed to be priority displayed items 105. Contacts may be added to the whitelist if the user of the device typically responds to the contact's texts or messages within a threshold time interval. For example, the threshold time interval may be 24 or 48 hours for texts and 48 or 72 hours for voice mail. Such response times may be determined based on the user's response to the contact within an average response time, a median response time or a mode response time, or other statistical measures. Similarly, a group of contacts of a group chat may be added to the whitelist.

In addition, or instead, a blacklist approach may be used to determine whether texts or other messages of a contact have priority. For example, a user may show no particular interest in texts or messages of a first user or first group of users. Thus, it may be determined that the user responds to most texts or messages within an average, median or mode time interval. This time interval may be set as a threshold time. It may then be determined that the user does not respond to a first user or first group of users within the threshold time. In such a case, the text or message received from any other user would be a priority displayed item 105 but a text or message received from the first user or first group of users may be deemed not to have priority.

According to an embodiment, the displayed item 105 determined to have priority would be in addition to icons in the dock or system status information, time/date information and the like typically positioned at peripheral areas of the screen would not be considered to have priority. In this embodiment, such icons in the dock or system status information and the like may or may not be displayed in addition to priority displayed items 105 simultaneously with second window 111.

If at 908 one or more items of the first window 103 are judged to have priority (“Yes”), then at 910 the second window 111 is positioned or formatted to avoid obscuring the displayed items 105. According to an embodiment, the content window 111 may be positioned to avoid obscuring the priority displayed item 105 when the display, or the payload portion of the display that does not include the peripheral areas of the display, as discussed, has sufficient space for both the priority displayed item 105 and the second window 111. If there is insufficient space on the screen for both then the second window 111 may be formatted, by reducing the size of the content window from predetermined size or default size. Or the second window 111 may be reformatted to be partially transparent.

On the other hand, if at 908 it is determined that none of what is in the first window 103 has priority (“No”), then processing returns to 904.

At 912, it is determined whether the position of the priority displayed item 105 has changed on the display 101 so that it now would be obscured by the second window 111 in its current position. If so (“Yes”), then processing returns to 912 and the second window 111 may be re-positioned. Also, if the user has scrolled or otherwise adjusted the first window 103 so that a new priority display item 105′ is now shown, then this may trigger re-positioning of the second window 111. Or, the second window 111 may then be formatted to a smaller size or to be partially transparent to allow visibility of both the old and the new priority display items 105, 105′.

At 914 the system determines whether the priority display item 105 has lost priority. For example, the user may have selected unread notifications and have scrolled past them, or based on an expiration of a time interval, for example 30 seconds or a minute after the user has been displayed the priority display item 105, it may be determined that the priority display displayed item 105 has lost priority.

If it is determined that the displayed item 105 has lost priority then processing continues to 916. On the other hand, if it is determined at 914 that the displayed item 105 has not lost priority, then processing returns to 910 where the second window 111 is continued to be positioned and/or formatted to avoid obscuring the priority displayed item 105.

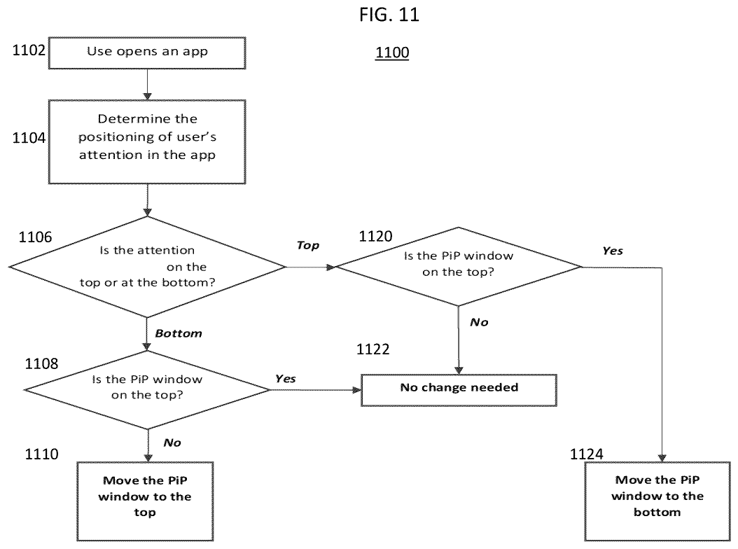

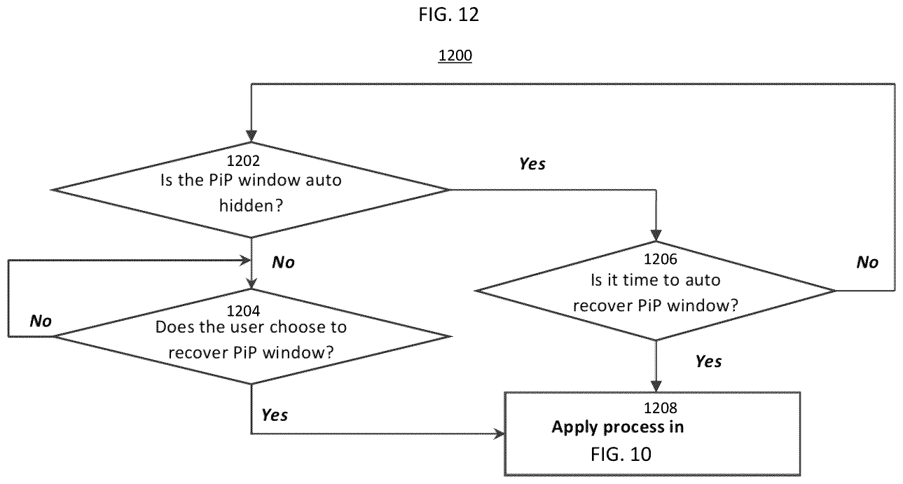

FIG. 10 illustrates an example of a process for determining second window 111 position and format. The method 1000 may be implemented, in whole or in part, by the system 199 shown in FIG. 1 or the system 199 shown in FIG. 8. One or more actions of the method 900 may be incorporated into or combined with one or more actions of any other process or embodiments described herein. The method 1000 may be saved to a memory or storage (e.g., the storage 808 of the system 199 shown in FIG. 8) as one or more instructions or routines, which may be executed by any suitable device or system having access to the memory or storage to implement the method 1000.

At 1002, it is determined whether the second window 111 is to be returned to the home screen of the device 100. For example, a user may be streaming a first content and then may press the home button or otherwise indicate a return to the home screen of the device. If it is determined that the second window 111 is not to be returned to the home screen (“No”), then at 1010 the second window 111 may be adjusted by the user as needed within the native application that is providing the second window 111.

On the other hand, if at 1002 it is determined that the second window 111 is to be returned to the home screen (“Yes”), then at 1004 it is determined whether the second window at current size or at default size would block priority display items 105 of the first window 103. If not (“No”), then at 1012 the second window 111 is moved to the default position at the default position and format or to its previous position and previous format.

If the second window 111 would block the priority displayed item 105 (“Yes” at 1004), then at 1006 the position of the priority displayed item 105 is determined and another position or format for the second window 111 is determined. For example, the coordinates of the pixels providing the priority display item 105 may be compared with the coordinates of the pixels providing the second window 111 to determine obstruction by the second window 111.

At 1008, the position and/or the format—e.g., size and/or transparency—of the second window 111 may be determined or adjusted to an optimal position.

In an embodiment, if both the top portion and the bottom portion of the display can comfortably accommodate the second window 111 without interfering with visibility of the displayed item 105, then the second window 111 may be positioned where it is more distant from a center of the priority item or from a near most portion of the displayed item 105. For instance, if the displayed item 105 is closer to the top of the display, then the second window 111 can be placed at the bottom of the display.

FIG. 11 shows an example of a process for re-positioning and/or re-formatting the second window 111. At 1102 the user opens an application. The method 1100 may be implemented, in whole or in part, by the system 199 shown in FIG. 1 or the system 199 shown in FIG. 8. One or more actions of the method 1100 may be incorporated into or combined with one or more actions of any other process or embodiments described herein. The method 1100 may be saved to a memory or storage (e.g., the storage 808 of the system 199 shown in FIG. 8) as one or more instructions or routines, which may be executed by any suitable device or system having access to the memory or storage to implement the method 1100.

At 1104, it is determined that the positioning that the user's attention in the application is focused at a particular location. The place of user's attention may be determined based on with which items the user is interacting, as discussed above.

At 1106, it is determined whether the user's attention is at or near the top or bottom of the display 101.

If it is determined at 1106 that the user's attention is at the top (“Bottom”) then at 1108 it is determined whether the second window 111 is currently positioned at the top. If it is “yes” then processing moves to 1122 since no change is needed.

But if it is determined at 1108 that the second window 111 is not currently at or near the top (“No”), then processing moves to 1110 and the second window 111 is moved to the top.

If at 1106 is determined that the user's attention is currently at the top (“Top”), then at 1120 it is determined whether the second window 111 is currently at or near the top. If so, no change is needed (“No”) and processing moves to 1122. However, if the second window 111 is currently positioned at or near the top (“Yes”), then at 1124 the second window 111 is moved to the bottom.

In an embodiment, the second window 111 may be automatically hidden to avoid obscuring the priority displayed item 105. For example, when no space is available for the second window 111 without obscuring any priority displayed items 105, then second window 111 may be hidden. As displayed items lose priority status, the second window 111 may be automatically brought back to the display 101.

The first content may also be other types of media content, such as a music with album cover, cover art, or an image of the performer or composer continuously displayed in the window. If the first content is audio-centric, for example, then the second window 111 may be automatically hidden so as not to obstruct the priority display item 105 of the first window 103. The second window 111 may be automatically re-provided on the display 101 as priority display items 105 lose priority status. Or, it may be determined that since the second window 111 is audio-centric, PiP window mode will be suppressed for as long as the user is interacting with any portion of the first window 103.

FIG. 12 is an example of a process for controlling the auto hide of the second window 111. The method 1200 may be implemented, in whole or in part, by the system 199 shown in FIG. 1 or the system 199 shown in FIG. 8. One or more actions of the method 1200 may be incorporated into or combined with one or more actions of any other process or embodiments described herein. The method 1200 may be saved to a memory or storage (e.g., the storage 808 of the system 199 shown in FIG. 8) as one or more instructions or routines, which may be executed by any suitable device or system having access to the memory or storage to implement the method 1200.

At 1202 it is determined whether the second window is currently auto hidden. If it is not (“No”), then at 1204 it may be determined whether the user wishes to manually recover the second window 111 from a state in which the second window was hidden manually by the user.

If yes, then processing may continue as shown in FIG. 10. In the user does not choose to view the second window 111, then user action may continue to be monitored to determine whether the user wants to recover it.

On the other hand, if at 1202 it is determined that the second window is auto-hidden (“Yes”), then at 1206 it is determined whether the second window 111 is to be automatically recovered and displayed again. If it is not (“No”), then processing returns to 1202. If it is to be automatically recovered (“Yes”), then processing moves to 1208, which may be a process as shown in FIG. 10.

The term “and/or,” may be understood to mean “both or either” of the elements thus indicated. Further, unless expressly stated to the contrary, “or” refers to an inclusive or and not to an exclusive or. For example, a condition A or B is satisfied by any one of the following: A is true (or present) and B is false (or not present); A is false (or not present) and B is true (or present); and both A and B are true (or present). Additional elements may optionally be present unless excluded by the context. Terms such as “first,” “second,” “third” in the claims referring to a structure, module or step should not necessarily be construed to mean precedence or temporal order but are generally intended to distinguish between claim elements.

The above-described embodiments are intended to be examples only. Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Components or processes described as separate may be combined or combined in ways other than as described, and components or processes described as being together or as integrated may be provided separately. Steps or processes described as being performed in a particular order may be re-ordered or recombined.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

Systems and/or methods described above may be applied to, or used in accordance with, other systems and/or methods. In various embodiments, additional elements may be included, some elements may be removed, and/or elements may be arranged differently from what is shown. Alterations, modifications and variations can be effected to the particular embodiments by those of skill in the art without departing from the scope of the present application, which is defined solely by the claims appended hereto.

1. A method comprising:
generating for display a content on a display of a user device;
generating for display, on the display of the user device, a first window comprising a displayed item,
determining that the displayed item of the first window has priority relative to the content;
in response to the determining, generating for display the content in a second window on the display of the user device simultaneously with the display of the first window, wherein the second window including the content is positioned or formatted to avoid obscuring the displayed item of the first window.

2. The method of claim 1, wherein the second window is displayed as a picture-in-picture overlaid on the first window in a position to avoid obscuring the displayed item.

3. The method of claim 1, wherein the second window is displayed as a picture-in-picture overlaid on the second window in a format to avoid obscuring the displayed item.

4. The method of claim 1, wherein the second window is displayed as a picture-in-picture overlaid on the displayed item in a format sufficiently transparent to allow simultaneous visibility of both the displayed item and the content.

5. The method of claim 1, wherein the second window is displayed as a picture-in-picture overlaid on the first window in a position different from a predetermined default picture-in-picture position of the display.

6. The method of claim 1, further comprising:
sizing the second window such that the second window is displayed in a window adjacent the first window simultaneously with the display of the second window.

7. The method of claim 1, wherein the second window is displayed as a picture-in-picture
overlaid over the first window.

8. The method of claim 1, wherein the displayed item is a user notification, and the first window is generated by a messaging application of the device,
wherein the display of the first window is generated in response to a receipt of the user notification.

9. The method of claim 1, wherein the displayed item is a notification, and the
displayed
item is determined to have priority based on a time of receipt of the notification or based on a time of generation, by a process of the device, of the notification.

10. The method of claim 1, wherein the displayed item is of a first item type, and the
priority
of the displayed item is determined based on a stored pattern of user interactions with the first item type.

11. The method of claim 1, further comprising:
determining that the displayed item is positioned at a second location of the display, the second location being different from an initial display position of the displayed item; and
in response to the determining that the displayed item is positioned at a second location, re-positioning the second window to avoid obscuring the displayed item.

12. The method of claim 1, wherein the displayed item is a first displayed item, and
the
method further comprises:
determining a change to the first window;
determining that a second displayed item of the first window has priority relative to the content in the second window, wherein the second displayed item is different from the first displayed item;
in response to the determining that that the second displayed item of the first window has priority relative to the content in the second window, repositioning or reformatting the second window to avoid obscuring the second displayed item of the first window.

13. The method of claim 12, wherein prior to the determining of the change to the
first window, the first window provides a user interface for a first application, and
wherein the determining of the change to the first window comprises determining that the first window is providing a user interface for a second application instead of the user interface for the first application.

14. The method of claim 1, further comprising:
determining that the displayed item has lost the priority; and
adjusting the display of the second window to a predetermined position or to a predetermined format, wherein the predetermined position or the predetermined format is not configured to avoid obscuring the displayed item.

15. The method of claim 14, wherein the displayed item is determined to have lost
the
priority based on a scrolling user input, a cursor user input, or an expiration of a priority time interval.

16. The method of claim 1, wherein the first window is generated by a first
application and
the second window is generated by a second application different from the first application.

17. The method of claim 1, further comprising:
receiving user input that initiates launching the first window on the display; and
entering a picture-in-picture mode in response to the launching of the first window.

18. A system comprising:
a memory configured to store instructions; and
processing circuitry configured:
to generate for display a content on a display of a user device;
to generating for display, on the display of the user device, a first window comprising a displayed item,
to determine that the displayed item of the first window has priority relative to the content; and
in response to the determining, to generate for display the content in a second window on the display of the user device simultaneously with the display of the first window, wherein the second window including the content is positioned or formatted to avoid obscuring the displayed item of the first window.

19. The system of claim 18, wherein the second window is displayed as a picture-in-picture overlaid on the first window in a position to avoid obscuring the displayed item.

20. The system of claim 18, wherein the second window is displayed as a picture-in-picture overlaid on the second window in a format to avoid obscuring the displayed item.

21. The system of claim 18, wherein the second window is displayed as a picture-in-picture overlaid on the displayed item in a format sufficiently transparent to allow simultaneous visibility of both the displayed item and the content.

22. The system of claim 18, wherein the second window is displayed as a picture-in-picture overlaid on the first window in a position different from a predetermined default picture-in-picture position of the display.

23. The system of claim 18, further comprising:
sizing the second window such that the second window is displayed in a window adjacent the first window simultaneously with the display of the second window.

24. The system of claim 18, wherein the second window is displayed as a picture-in-picture
overlaid over the first window.

25. The system of claim 18, wherein the displayed item is a user notification, and the first window is generated by a messaging application of the device,
wherein the display of the first window is generated in response to a receipt of the user notification.

26. The system of claim 18, wherein the displayed item is a notification, and the
displayed
item is determined to have priority based on a time of receipt of the notification or based on a time of generation, by a process of the device, of the notification.

27. The system of claim 18, wherein the displayed item is of a first item type, and the
priority
of the displayed item is determined based on a stored pattern of user interactions with the first item type.

28. The system of claim 18, further comprising:
determining that the displayed item is positioned at a second location of the display, the second location being different from an initial display position of the displayed item; and
in response to the determining that the displayed item is positioned at a second location, re-positioning the second window to avoid obscuring the displayed item.

29. The system of claim 18, wherein the displayed item is a first displayed item, and
the
processing circuitry is configured:
to determine a change to the first window;
to determine that a second displayed item of the first window has priority relative to the content in the second window, wherein the second displayed item is different from the first displayed item; and
in response to the determining that that the second displayed item of the first window has priority relative to the content in the second window, to reposition or reformatting the second window to avoid obscuring the second displayed item of the first window.

30. The method of claim 29, wherein prior to the determining of the change to the
first
window, the first window provides a user interface for a first application, and
wherein the determining of the change to the first window comprises determining that the first window is providing a user interface for a second application instead of the user interface for the first application.

31. The method of claim 18, wherein the processing circuitry is configured:
to determine that the displayed item has lost the priority; and
to adjust the display of the second window to a predetermined position or to a predetermined format, wherein the predetermined position or the predetermined format is not configured to avoid obscuring the displayed item.

32. The method of claim 31, wherein the displayed item is determined to have lost the priority based on a scrolling user input, a cursor user input, or an expiration of a priority time interval.

33. The method of claim 18, wherein the first window is generated by a first
application and
the second window is generated by a second application different from the first application.

34. The method of claim 18, the processing circuitry is configured:
to receive user input that initiates launching the first window on the display; and
to enter a picture-in-picture mode in response to the launching of the first window.

35-85. (canceled)
